(19) United States
(12) Patent Application Publication
(10) Pub. No.: US 2010/0127486 A1
(43) Pub. Date: May 27, 2010

(54) Inflator

(75) Inventor: Junichi Asanuma, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/591,321

(22) Filed: Nov. 17, 2009

(30) Foreign Application Priority Data
Nov. 25, 2008 (JP) 2008-299924

(51) Int. Cl. B60R 21/26

(52) U.S. Cl. 280/737

(57) ABSTRACT

An inflator includes a compressed gas chamber defined by closing an exit hole with a rupture plate, a housing which holds a gas generator which can rupture the rupture plate and which has discharge ports from which a compressed gas can be discharged to the outside, and a guide for guiding a combustion gas from the gas generator to the rupture plate so as to rupture the rupture plate. The guide includes a substantially cylindrical spouting tube portion which extends toward the exit port at a distal end thereof, a mounting seat which is disposed at a proximal portion of the spouting tube portion and a connecting portion disposed between the mounting seat and the spouting tube portion. The guide is installed so as to be held to a holding tube portion with the spouting tube portion extending towards the exit port while defining a space H between an inner circumferential surface of a connecting tube portion of the housing and the spouting tube portion so extending and the mounting seat kept in abutment with a riser surface of the housing.

### BACKGROUND OF THE INVENTION

1. Field of the Invention

The present invention relates to an inflator which is configured to discharge a compressed gas sealed in a compressed gas chamber from discharge ports by rupturing a rupture plate by a combustion gas spouted from a gas generator when the inflator is activated and relates to, for example, an inflator which can preferably be used in an airbag system which is installed on a vehicle for inflating an airbag to protect an occupant inside or a pedestrian outside of the vehicle.

2. Related Art

Conventionally, an inflator of this type includes a compressed gas chamber defined by closing an exit portion from which a compressed gas sealed therein is allowed to exit with a rupture plate and a housing installed so as to be consecutive to the exit port of the compressed gas chamber for holding a gas generator (a micro gas generator) which can rupture the rupture plate by a combustion gas spouted therefrom when the gas generator is activated. In addition, the housing has discharge ports formed between the gas generator and the exit port for discharging the compressed gas which flows out as a result of the rupture of the rupture plate to the outside thereof (for example, refer to JP-A-2006-502030).

In the inflator of this type, although an output of the generator is made small, for the rupture plate to be ruptured smoothly when the inflator is activated, a guide is provided at a gas exit port of the gas generator so as to cause an inflation gas spouted to converge on the rupture plate. This guide is formed so that an inner circumference thereof is narrowed in a tapered fashion towards a distal end thereof so that a combustion gas spouted from the gas generator is allowed to exit from a distal end with the flow velocity thereof increased so as to be concentrated on a small area on the rupture plate for a smooth rupture of the rupture plate.

In the inflator including the conventional guide for causing the combustion gas to converge, however, the guide is assembled closely on to an outer circumferential surface of the gas generator while extending from the gas generator towards the exit port, and further, the guide is inserted together with the gas generator into the housing from an opening on a side of the housing which faces the exit port. In addition, in order to restrict the movement of the guide towards the exit port of the housing, the guide is fixed to the housing by a distal end of the housing which lies on the exit port thereof being crimped to be bent into annular groove on the guide.

Namely, the assemblage of the conventional guide involves too many labor hours because a distal end of the housing is bent while being plastically deformed so that the guide is locked at an end face portion of the housing which faces the exit port so as to restrict the movement of the guide towards the exit port so that the guide is not dislocated from the gas generator towards the exit port by the combustion gas spouted from the gas generator. For example, when a compressed gas is sealed in the compressed gas chamber by increasing a pressure imposed thereon, the strength of the rupture plate needs to be increased, and as this occurs, as to the converging form in which the combustion gas converges on the rupture plate, a converging form needs to be adopted in which the combustion gas is caused to converge on a narrower area so as to rupture the rupture plate whose strength is so increased. However, as this occurs, a construction is then required in which the guide is locked on the housing with a stronger force so that the guide is not dislocated from the gas generator, and with the conventional inflators, there is still room for improvement in the holding construction of the guide by the housing.

### SUMMARY OF THE INVENTION

The invention has been made with a view to solving the problem, and an object thereof is to provide an inflator in which a guide can be held to a housing strongly and stably even when the guide is assembled to the housing by simple assembling work.

According to an aspect of the invention, there is provided an inflator comprising:

a compressed gas chamber defined by closing an exit port through which a compressed gas sealed therein is allowed to exit with a rupture plate;

a housing installed so as to be consecutive to the compressed gas chamber which holds a gas generator which can rupture the rupture plate by a combustion gas spouted therefrom when the gas generator is activated and which has discharge ports formed between the gas generator and the exit port for discharging the compressed gas which flows out as a result of the rupture of the rupture plate to the outside thereof; and

a guide for converging the combustion gas spouted from the gas generator so as for the combustion gas to be guided to the rupture plate for promoting the rupture thereof, wherein

the guide comprises:

a spouting tube portion having a substantially cylindrical shape which extends to face the exit port at a distal end and of which an inside diameter dimension is made smaller than an opening dimension of the exit port;

a mounting seat which is disposed at a proximal portion of the spouting tube portion and which extends in a direction which intersects an axis of the spouting tube portion at right angles in a flange-like shape; and

a connecting portion having a bent plate shape which bends from the mounting seat to an inner circumferential side of the spouting tube portion into a substantially arc-like shape and disposed at a boundary portion between the mounting seat and the spouting tube portion, wherein

the housing comprises:

a holding tube portion for holding the gas generator on an inner circumferential side thereof; and

a connecting tube portion disposed to extend from the holding tube portion to the exit port, having a riser surface which extends from an inner circumferential surface of the holding tube portion towards an axis of the holding tube portion, extending towards the exit port with an inside diameter dimension made smaller than that of the holding tube portion and lying consecutive to the compressed gas chamber with the discharge ports provided so as to penetrate from an inner circumference to an outer circumference thereof, and wherein

the guide is installed with the spouting tube portion extending towards the exit portion while defining a space between an inner circumferential surface of the connecting tube portion and itself and the mounting seat brought into abutment with the riser surface so as to be held on the holding tube.

In the inflator according to the aspect of the invention, when the gas generator is activated to spout the combustion gas, the combustion gas strikes the rupture plate by way of the spouting tube portion of the guide. When this occurs, since the spouting tube portion of the guide extends towards the exit port at the distal end thereof and the inside diameter dimension of the spouting tube portion is made smaller than that of the exit port, the combustion gas can be concentrated to a smaller area on the rupture plate with the flow velocity thereof increased when the combustion gas exits from the distal end of the spouting tube portion whose opening is narrowed, so as to rupture the rupture plate smoothly. Then, when the rupture plate is ruptured, the exit port of the compressed gas chamber is opened, and the compressed gas flows towards the discharge ports in the connecting tube portion by passing between the spouting tube portion of the guide and the connecting tube portion of the housing so as to be discharged from the discharge ports.

The mounting seat of the guide is brought into abutment with the riser surface of the housing which is disposed so as to be opposed to the direction in which the combustion gas is spouted from the gas generator. Because of this, even in the event that the combustion gas is spouted from the gas generator to thereby impose a pressure at which the combustion gas is so spouted from the mounting seat to the inner circumferential surface of the connecting tube portion and further to the inner circumferential surface of the spouting tube portion, the riser surface of the housing can receive the mounting seat which attempts to move in the spouting direction of combustion gas in a squared fashion, whereby the guide can be kept held strongly to the housing. The guide only has to simply be held to the holding tube portion with the mounting seat in abutment with the riser surface of the housing, and the guide can easily be assembled to the housing by being welded to or press fitted in the portion of the housing where the riser surface is provided. In other words, the riser surface of the housing only receives the compression load when receiving the pressure at which the combustion gas is spouted via the mounting seat, and compared with the conventional inflators in which for the assemblage of the guide, the guide is locked on the housing by crimping the housing to bend it through plastic deformation, a sufficient thickness dimension in the spouting direction of combustion gas can easily be secured in advance without bending the housing when the guide is assembled thereto. As a result, the housing is allowed to hold the guide strongly and rigidly in an easy fashion by the simple construction of the riser surface and the simple assembling work.

Further, since the guide is not assembled to the gas generator but is assembled to the housing, in the event that a change is required in the converging form of combustion gas on the rupture plate by changing the length and/or inside diameter of the spouting tube portion, the shape of the mounting seat where the guide is assembled to the housing or the portion of the housing where the guide is assembled does not have to be changed, and hence, the change can easily be dealt with while the simple assembling work to the housing is maintained.

Consequently, in the inflator according to the aspect of the invention, even with the simple assembling work, the guide can be held to the housing stably, and further, even in the event that the change is required in the converging form of combustion gas on the rupture plate, the change can easily be dealt with.

In the inflator according to the aspect of the invention, in the event that the guide is configured to be held in the housing by the mounting seat being press fitted in a portion of the holding tube portion in the housing where the riser surface is situated, the assembling work of the guide to the housing is facilitated, reducing the manhours and costs involved in fabrication of the inflator.

Further, in the inflator according to the aspect of the invention, in the event that the gas generator is provided with a plurality of door portions on a surface thereof which faces the exit port which open at rupture portions formed to be ruptured radially from a center thereof when the combustion gas is spouted when the inflator is activated, it is desirable that the guide is held in the housing and is disposed in a position where the guide can receive the respective doors which open when the gas generator spouts the combustion gas by an inner circumferential surface of the connecting portion.

In this configuration, when the individual door portions of the gas generator open when the inflator is activated, the inner circumferential surface of the connecting portion of the guide receives the individual doors. The connecting portion has the bent plate shape which is bent into the substantially arc shape from the mounting seat to the inner circumference of the spouting tube portion, and the individual door portions which are received by the connecting portion open into the bent plate shape at an opening angle of about less than 90°. This suppresses the centrifugal force that would otherwise be imposed on the door portions, whereby a stress concentration in the vicinity of hinge portions which constitute centers of the opening of the individual door portions is made difficult to take place, thereby making it possible to prevent the separation of the door portions from the vicinity of the hinge portions in a proper fashion.

### BRIEF DESCRIPTION OF THE DRAWINGS

FIG. 1 is a schematic sectional view of an inflator which is an embodiment of the invention.

FIG. 2 is a partial enlarged sectional view showing the vicinity of a guide in the inflator shown in FIG. 1.

FIG. 3 is a partial enlarged sectional view showing the vicinity of the guide when the inflator shown in FIG. 1 is activated.

FIG. 4 is a partial enlarged perspective view showing the vicinity of a distal end wall portion of a cup portion in a gas generator of the inflator shown in FIG. 1.

FIGS. 5A and 5B are perspective views of the guide used in the inflator shown in FIG. 1, showing states in which the guide is shown from a front side and a rear side thereof.

FIG. 6 is a partial enlarged sectional view in the vicinity of a guide which results when the guide of the inflator shown in FIG. 1 is changed.

### DETAILED DESCRIPTION OF THE PREFERRED EMBODIMENTS

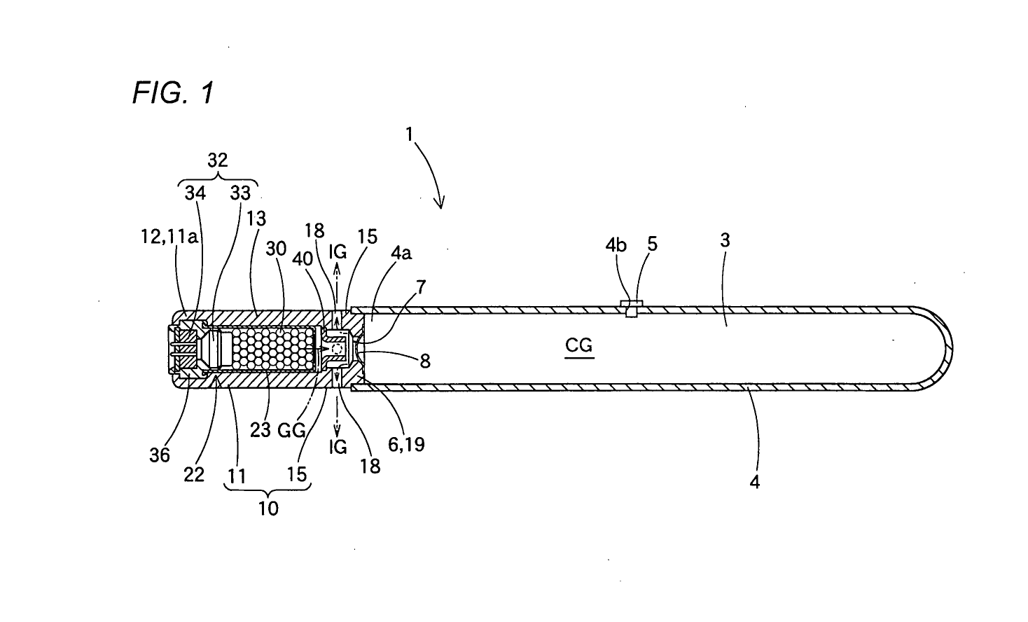

Hereinafter, an embodiment of the invention will be described based on the drawings. An inflator 1 according to the embodiment shown in FIG. 1 is used for discharging an inflation gas for inflating an airbag of an airbag system installed on a vehicle and for this inflator, an inflator of a hybrid type is adopted in which an inflation gas IG which is a mixture of a compressed gas CG and a combustion gas GG is discharged from discharge ports 18.

As is shown in FIG. 1, the inflator 1 of this embodiment includes a compressed gas chamber 3 in which the compression gas CG is sealed, a housing 10 which holds a gas generator 22 and a guide 40. The compressed gas chamber 3 is made up of a substantially cylindrical steel bottle 4, and an opening 4a at a proximal portion of the bottle 4, which lies away from a closed distal end portion of the bottle 4, is closed by a closing wall 6. An exit port 7 is provided in the closing wall 6, and the exit port 7 is closed by a rupture plate 8 made up of a steel plate or the like. The compression gas CG is made up of a nitrogen gas, a helium gas, an argon gas or a mixture thereof, and the compression gas CG is filled in the compressed gas chamber 3 from a filling port 4b. The filling port 4b is closed by a sealing cap 5 which is welded to the bottle 4 after the compressed gas CG has been filled. In the case of this embodiment, the closing wall 6 is made by a diametrically contracted portion 19 at a distal end of the housing 10 being welded to an inner circumferential side of the opening 4a, and the rupture plate 8 is secured to the diametrically contracted portion 19 from an inner circumferential side of the compressed gas chamber 3 so as to close the exit port 7 described above at a distal end face side 20 of the diametrically contracted portion 19 where the exit port 7 is opened.

The gas generator 22 includes a cup portion 23 in an interior of which gas generants 30 are filled, an ignition squib 32 for burning the generants 30 to produce a combustion gas GG; and a holder 36 for connecting the cup portion 23 and the squib portion 32 together. In the squib 32, an ignition portion 33 is installed at a distal end thereof which constitutes a side facing the cub portion 23 and a terminal portion 34 is installed at a proximal portion thereof facing the housing 10, and a lead wire, not shown, is connected to the terminal portion 34 for inputting an electrical signal for igniting the ignition portion 33.

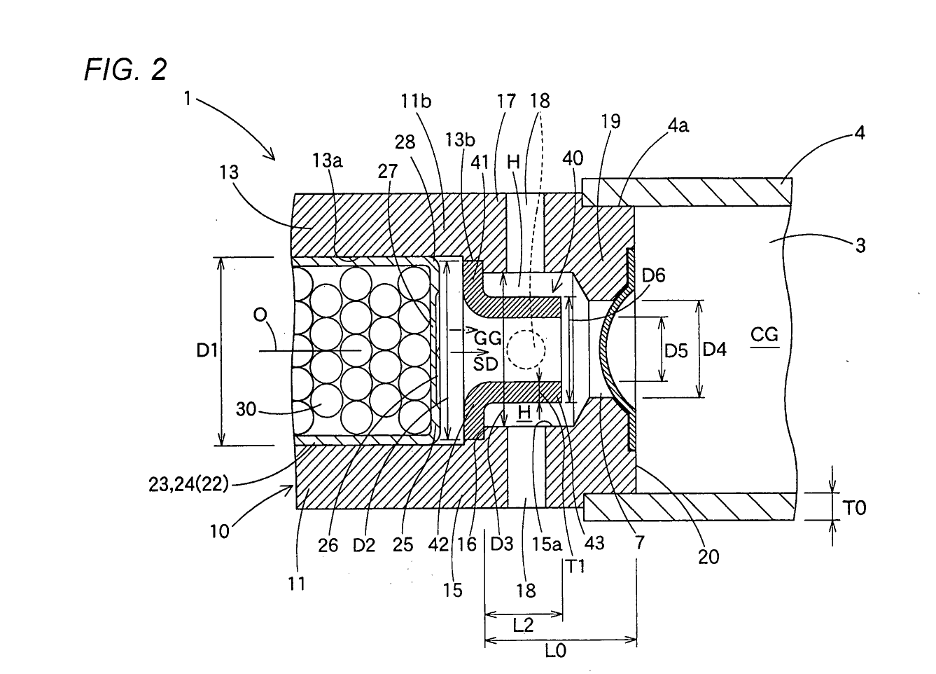

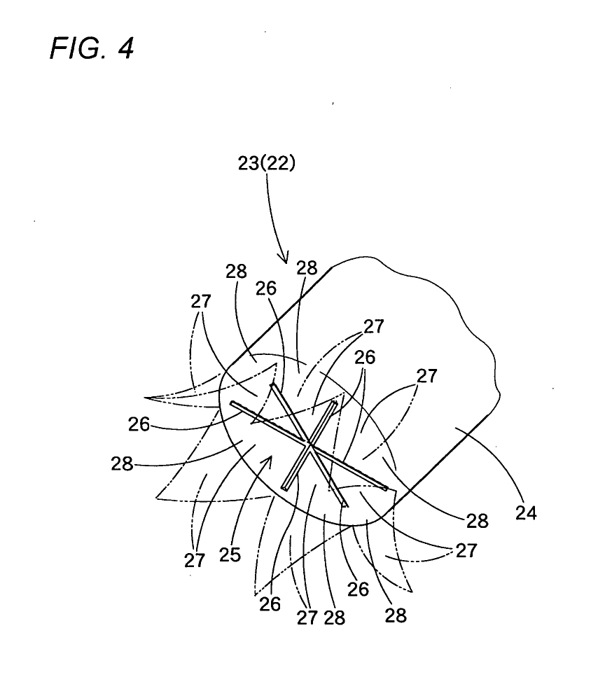

As is shown in FIGS. 2 and 4, the cup portion 23 is made of a metal such as an aluminum alloy and includes a cylindrical circumferential wall portion 24 and a distal end wall portion 25 which is installed to close the circumferential wall portion 24 at a distal end of the circumferential wall portion 24 which faces the exit port 7. As is shown in FIG. 4, thin rupture occurring portions 26, where ruptures are expected to occur when the gas generator 22 is activated (when the gas generants 30 are burnt), are formed to extend linearly in a substantially radial direction from a center of the distal end wall portion 25. In the case of this embodiment, the rupture occurring portions 26 are made by providing continuous cuts of a depth of the order of one half of the thickness of the distal end wall portion 25 on an external surface of the distal end wall portion 25, and the rupture occurring portions 26 are formed at a plurality of portions (six portions in the case of this embodiment) on the distal end wall portion 25 so as to extend in the radial direction from the center of the distal end wall portion 25. To describe this in greater detail, the rupture occurring portions 26 are not formed so as to divide the distal end wall portion 25 but are formed so that end portions of the rupture occurring portions 26 lie slightly further inwards than an outer circumferential edge of the distal end wall portion 25. Portions of the distal end wall portions 25 which are situated between the rupture occurring portions 26 are defined as door portions 27, and these six door portions 27, each having a substantially triangular plate shape, are allowed to open radially from portions in the vicinity of a boundary portion with the circumferential wall portion 24 (in the vicinity of an outer circumferential edge of the distal end wall portion 25) as hinge portions 28 which constitute centers of the opening of the door portions 27 when the rupture occurring portions 26 are ruptured as a result of the activation of the gas generator 22.

The gas generants 30 are made by forming a predetermined chemical, which can produce a combustion gas GG when they are burnt, into a predetermined shape, and in the case of the embodiment, the gas generants 30 are formed into a substantially spherical shape and are filled in the cup portion 23 (refer to FIGS. 1 and 2).

As is shown in FIG. 1, the holder 36 is made of a metal such as an aluminum alloy and has a substantially cylindrical shape. The holder 36 is crimped to be diametrically contracted at front and rear ends thereof with the cup portion 23 and the squib 32 inserted therein, so as to hold the cup portion 23 and the squib 32 so that they are joined together.

As is shown in FIG. 1, the housing 10 is made of a metal such as steel and has a substantially cylindrical shape. The housing 10 is installed to be consecutive to an opening 4a of the bottle 4 which lies at a proximal portion of the compressed gas chamber 3. The housing 10 includes a holding tube portion 11 for holding the gas generator 22 on an inner circumferential side thereof and a connecting tube portion 15 which extends from the holding tube portion 11 towards the compressed gas chamber 3.

The holding tube portion 11 includes a crimping portion 12 which is disposed at an end of a proximal portion 11a (refer to FIG. 1) for crimping the holder portion 36 of the gas generator 22 so as to hold the gas generator 22 so as not to move back and forth and a cylindrical straight portion 13 which extends from the crimping portion 12 to a distal end portion 11b (refer to FIG. 2) which lies to face the exit port 7 with an inside diameter dimension thereof remaining constant.

As is shown in FIG. 2, the connecting tube portion 15 includes a straight portion which lies consecutive to the straight portion 13 of the holding tube portion 11 and the diametrically contracted portion 19 which lies on a side thereof which faces the compressed gas chamber 3. The straight portion 17 extends towards the exit port 7 and is formed into a cylindrical shape. An inside diameter dimension D3 of the straight portion 17 is made smaller than an inside diameter dimension D1 of the straight portion 13 of the holding tube portion 11 so as to have a riser surface 16 which extends from an inner circumferential surface 12a of the straight portion 13 of the holding portion towards an axis O of the holding portion 11. The diametrically contracted portion 19 is formed to extend from a distal end of the straight portion 17 while being diametrically contracted so that an inside diameter dimension D4 thereof is made narrower than the inside diameter dimension of the straight portion 17, and the exit port 7 is formed in the diametrically contracted portion 19. As has been described before, the rupture plate 8 is secured to the distal end face 20 of the diametrically contracted portion 19.

The plurality of (four, in the case of this embodiment) discharge ports 18 are opened in the straight portion 17 of the connecting tube portion 15 radially along a circumferential direction so as to penetrate through the straight portion 17 from an inner to an outer circumference thereof.

The straight portion 13 of the holding tube portion 11 includes, as is shown in

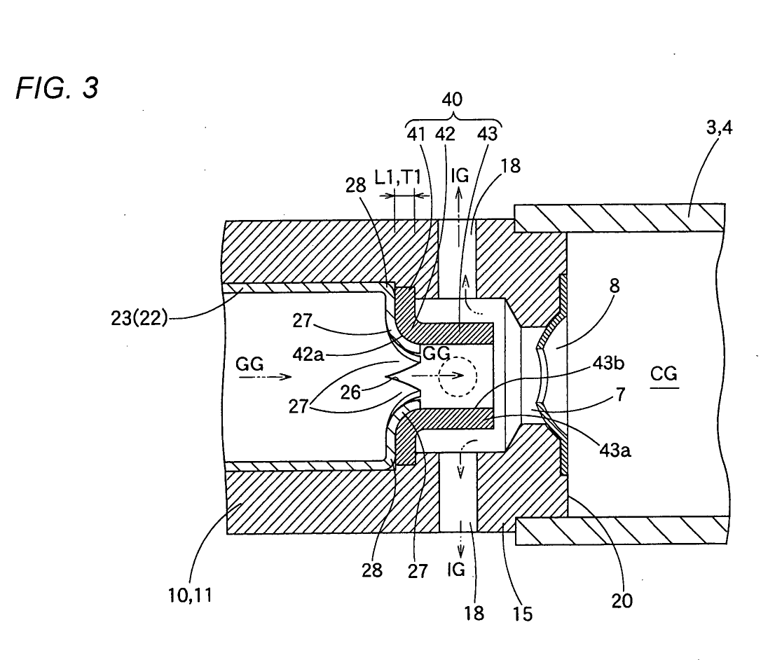

FIG. 2, a fitting portion 13b which are formed by slightly contracting the inner circumferential surface 13a in the diametrical direction at a portion lying in the vicinity of the rising surface 16. An inside diameter dimension D2 of this fitting portion 13b is set to such a dimension that enables the fitting of a mounting seat 41 of the guide 40 in the fitting portion 13b, and a length dimension L1 of the fitting portion 13b is set to be substantially equal to a thickness dimension T1 of the mounting seat 41 (refer to FIG. 3).

A thickness dimension L0 (refer to FIG. 2) of the riser surface 16 of the holding tube portion 11, which supports the mounting seat 41 of the guide 40, is set so as to have a sufficient strength. In the case of this embodiment, the thickness dimension L0 of the portion of the holding tube portion 11 where the riser surface 16 is formed is set so as to be referred to as a length from the riser surface 16 to the distal end surface 20 of the housing 10 and hence, a recess portion which recedes as deep as an area where the riser surface 16 is formed is not provided at all along the full circumference in the circumferential direction in an area extending from the riser surface 16 to the distal end surface 20.

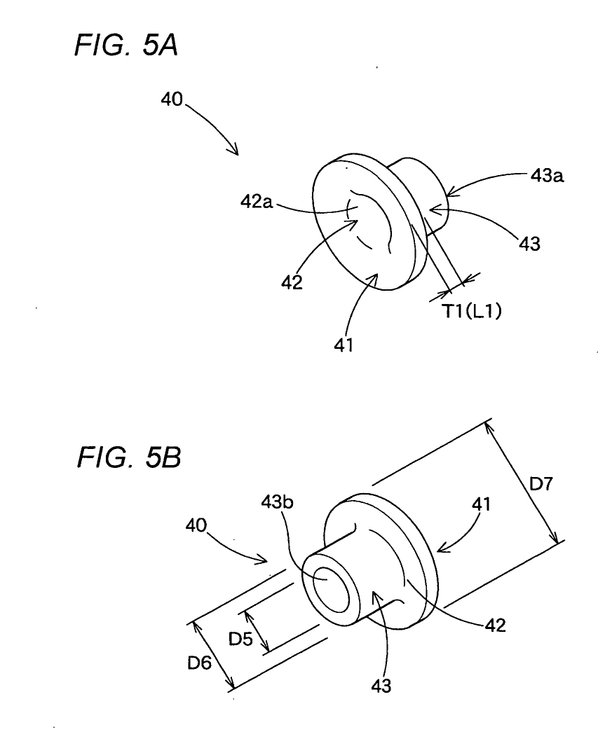

The guide 40 is made of a metal such as an ultra high strength steel and includes the mounting seat 41, a connecting portion 42 and a spouting tube portion 43, as is shown in FIGS. 2, 5A and 5B. The spouting tube portion 43 has a cylindrical shape whose inside diameter dimension D5 is made smaller than an opening dimension (the inside diameter dimension of the diametrically contracted portion 19) and extends towards the exit port 7 at a distal end 43a thereof. The mounting seat 41 is disposed at a proximal portion of the spouting tube portion 43 and has a substantially ring shape which extends in a flange-like shape in a direction which intersects an axis of the spouting tube portion 43 at right angles. The connecting portion 42 has a bent plate shape which is bent into a substantially arc shape (in the case of this embodiment, an arc of a quarter of a circle) from the mounting seat to an inner circumferential side of the spouting tube portion 43 and is disposed at a boundary portion between the mounting seat 41 and the spouting tube portion 43 so as to connect the mounting seat 41 to the spouting tube portion 43.

In the case of this embodiment, a thickness dimension T1 of the guide 40 is set so as to be equal at the respective constituent portions. Incidentally, in the case of this embodiment, the thickness dimension T1 of the guide 40 is referred to as 1.6 mm, and a thickness T0 of the bottle 4 is referred to as 2.0 mm.

Further, in this guide 40, an outside diameter D6 of the spouting tube portion 43 is made smaller than the inside diameter dimension D3 of the straight portion 17 so that the spouting tube portion 43 can extend towards the exit port 7 with a space H defined between an inner circumferential surface 15a of the connecting tube portion 15 and the spouting tube portion 43, and the guide 40 is installed so as to be held on to the housing 11 with the mounting seat 41 kept in abutment with the riser surface 16.

In the case of the embodiment, as is shown in FIG. 2, an outside diameter dimension D7 of the mounting seat 41 is set to be equal to the inside diameter dimension D2 of the fitting portion 13b or slightly smaller than the inside diameter dimension D2 so that the guide 40 is held to the housing 10 by the mounting seat 41 being fitted in the portion of the holding tube portion 11 of the housing 10 where the riser surface 16 is formed (the fitting portion 13b). Further, The outside diameter D6 of the spouting tube portion 43 is set to be equal to the inside diameter dimension D4 of the exit port 7.

The guide 40 is disposed so as to be fixed (held) to the holding tube portion 11 in a position where the door portions 27 which are opened when the combustion gas GG is spouted from the gas generator 22 can be received by an inner circumferential surface 42a of the connecting portion 42 (refer to FIG. 3).

In the inflator 1 of the embodiment, firstly, the guide 40 is inserted from the proximal portion 11a of the housing 10 into which the gas generator 22 has not yet been assembled with the spouting tube portion 43 making a leading end and is then press fitted in the fitting portion 13b of the holding tube portion 11 so that the mounting seat 41 is brought into abutment with the riser surface 16. Following this, the gas generator 22, in which the cup portion 23 which is filled with the gas generants 30 and the squib 32 are made integral with each other by the holder 36, is inserted into the holding tube portion 11, and the crimping portion 12 is crimped so as to hold the gas generator 22 on to the holding tube portion 11. Thereafter, the rupture plate 8 is secured to the distal end surface 20 of the housing 10, and then, the housing 10 is inserted into the opening 4a of the bottle 4 and is then welded to the bottle 4. Thereafter, a compressed gas CG is filled in the interior of the compressed gas chamber 3 from the filling port 4b, and the filling port 4a is closed by the sealing cap 5, whereby the inflator 1 can be fabricated.

In the inflator 1 of this embodiment, when the gas generator 22 is activated, the ignition portion 33 of the squib 32 is ignited, and the gas generants 30 are fired to produce a combustion gas GG The combustion gas GG so produced push opens the individual door portions 27 of the cup portion 23 so as to be spouted from the gas generator 22. Then, the combustion gas GG so spouted strikes the rupture plate 8 by way of the spouting tube portion 43 of the guide 40. As this occurs, since the spouting tube portion 43 of the guide 40 extends towards the exit hole 7 at the distal end thereof and the inside diameter dimension D5 of the distal end 43a of the spouting tube portion 43 is made smaller than the opening dimension (the inside diameter dimension) D4 of the exit port 7, the combustion gas GG is spouted from the distal end 43a whose opening is narrowed with the increasing flow velocity so as to be concentrated to the small area on the rupture plate 8, thereby making it possible to rupture the rupture plate 8 in a smooth fashion, as is shown in FIG. 3. When the rupture plate 8 is ruptured, the exit port 7 of the compressed gas chamber 3 is opened, and the compressed gas CG flows out of the exit port 7 so as to be mixed with the combustion gas GG for production of an inflation gas IG The inflation gas IG so produced then flows to a discharge port 18 of the connecting tube portion 15 by way of the space H defined between the spouting tube portion 43 of the guide 40 and the connecting tube portion 15 of the housing 10, so as to be discharged from the discharge ports 18.

In the inflator 1 of the embodiment, the guide 40 is installed in the housing 10 so that the mounting seat 41 is brought into abutment with the riser surface 16 of the housing 10 which is disposed so as to face the spouting direction SD of combustion gas GG from the gas generator 22. By this configuration, even in the event that the pressure at which the combustion gas GG is spouted is imposed from the mounting seat 41 on the inner circumferential surface 42a of the connecting portion 42 and further on the inner circumferential surface 43b of the spouting tube portion 43, the riser surface 16 of the housing 10 can receive the mounting seat 41 which attempts to move in the spouting direction SD of combustion gas GG in the squared fashion, whereby the guide 40 can be kept held to the housing 10 strongly and stably. The guide 40 only has to simply be held to the holding tube portion 11 with the mounting seat 41 kept in abutment with the riser surface 16 of the housing 10 and can easily be assembled to the housing 10 by being welded to or press fitted in the portion (the fitting portion) 13b of the housing 10 where the riser surface 16 is formed. In other words, when receiving the pressure at which the combustion gas GG is spouted via the mounting seat 41, the riser surface 16 of the housing 10 only has to receive the compression load, and the sufficient thickness dimension L0 in the spouting direction SD can easily be secured in advance without bending the housing 10 when the guide 40 is assembled, compared with the conventional inflator in which the housing is crimped to be bent for plastic deformation so as to lock the guide when the guide is assembled. As a result, the housing 10 is allowed to easily hold the guide 40 strongly by the simple construction of the riser surface 16 and the simple assembling work.

Since the guide 40 is not assembled to the gas generator 22 but is assembled to the housing 10, even in the event that a change is required in the converging form of the combustion gas GG on the rupture plate 8 by changing the length dimension L2 and/or the inside diameter D5 of the spouting tube portion 43, the shape of the mounting seat 41 which constitutes the portion where the guide 40 is assembled to the housing 10 or the assembling portion (the fitting portion 13b) on the housing 10 does not have to be changed, and the change can easily be dealt with while the simple assembling work to the housing 10 is maintained.

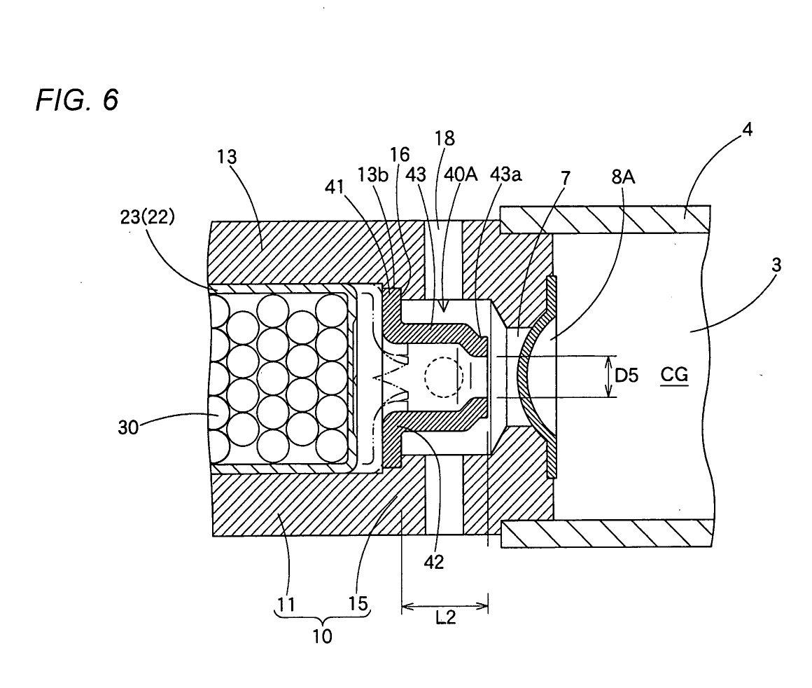

For example, in a guide 40A shown in FIG. 6, in order to rupture a rupture plate 8A whose strength is increased in conjunction with an increase in pressure of the compressed gas CG smoothly by the use of the gas generator 22 whose output remains unchanged, compared with the guide 40 shown in FIG. 2, the guide 40A is changed so that a length dimension L2 of a spouting tube portion 43 is lengthened and an inside diameter dimension D5 is made smaller. Namely, in this guide 40A, a converging form of combustion gas GG on the rupture plate 8 is configured so that the combustion gas GG is concentrated to a smaller area, and even in this case, the shape of the mounting seat 41 which constitutes the assembling portion of the guide 40A to the housing 10 or the assembling portion (the fitting portion 13b) on the housing 10 does not have to be changed, the change can easily be dealt with while the simple assembling work is maintained in which the guide 40A is press fitted in the fitting portion 13b for assemblage to the housing 10.

Consequently, in the inflator 1 of the embodiment, even though the simple assembling work is adopted, the guide 40/40A can be held to the housing 11 stably, and further, even in the event that a change is required in the converging configuration of combustion gas GG on the rupture plate 8/8A, the change can easily be dealt with.

In the inflator 1 of this embodiment, the guide 40/40A is configured to be held on to the housing 10 by the mounting seat 41 being press fitted in the portion (the fitting portion) 13b of the holding tube portion 11 where the riser surface 16 is formed, whereby the assembling work of the guide 40/40A to the housing 10 becomes easy, thereby making it possible to reduce the manhours and costs involved in the fabrication of the inflator 1.

Further, in the inflator 1 of the embodiment, the gas generator 22 is configured to include the plurality of door portions 27 which are formed on the side facing the exit port 7 so as to open at the rupture portions which are ruptured radially from the center thereof when the combustion gas GG is spouted from the gas generator 22 when it is activated. In addition, the guide 40 is held in the housing 10 and is disposed in the position where the individual door portions 27 can be received by the inner circumferential surface 42a of the connecting portion 42 when the door portions 27 are opened by the combustion gas GG spouted from the gas generator 22. Because of this, in the inflator 1 of the embodiment, when the individual door portions 27 of the gas generator 22 are opened when the gas generator 22 is activated, the inner circumferential surface 42a of the connecting portion 42 of the guide 40 is allowed to receive the door portions 27 so opened. The connecting portion 42 has the bent plate shape which bents into the substantially arc shape (in the case of the embodiment, the arc of a quarter of a circle) from the mounting seat 41 to the inner circumferential surface 43b of the spouting tube portion 43, and the individual door portions 27 which are received by the connecting portion 42 open into the bent plate shape at an opening angle of about less than 90°. This suppresses the centrifugal force that would otherwise be imposed on the door portions, whereby a stress concentration in the vicinity of the hinge portions 28 which constitute the centers of the opening of the individual door portions 27 is made difficult to take place, thereby making it possible to prevent the separation of the door portions 27 from the vicinity of the hinge portions 28 in a proper fashion.

In the inflator 1 of the embodiment, while the guide 40/40A is described as being held to the holding tube portion 11 of the housing 10 by being press fitted in the fitting portion 13b, the guide 40/40A may be held (fixed) to the holding tube portion 11 with the mounting seat 41 kept in abutment with the riser surface 16 by making use of welding such as resistance welding. Of course, the guide may be held to the holding tube portion by making use of press fitting and welding in parallel.

In addition, in the embodiment, while the hybrid type inflator in which the compressed gas and the combustion gas are mixed together to be discharged from the inflator is illustrated as being applied to the inflator, the invention may be applied to an inflator of a stored type in which a combustion gas spouted from a gas generator is used simply for rupturing a rupture plate.

Further, there exists a case in which the rupture plate is ruptured by a shock wave generated when the gas generator is activated, and even in that case, since the shock wave can be caused to converge to be spouted from the distal end of the spouting tube portion, the invention can be applied to the inflator in which the rupture of the rupture plate is mainly implemented by the shock wave produced when the gas generator is activated.

What is claimed is:

1. An inflator comprising:
a compressed gas chamber defined by closing an exit port through which a compressed gas sealed therein is allowed to exit with a rupture plate;
a housing installed so as to be consecutive to the compressed gas chamber which holds a gas generator which can rupture the rupture plate by a combustion gas spouted therefrom when the gas generator is activated and which has discharge ports formed between the gas generator and the exit port for discharging the compressed gas which flows out as a result of the rupture of the rupture plate to the outside thereof; and
a guide for converging the combustion gas spouted from the gas generator so as for the combustion gas to be guided to the rupture plate for promoting the rupture thereof, wherein
the guide comprises:
a spouting tube portion having a substantially cylindrical shape which extends to face the exit port at a distal end and of which an inside diameter dimension is made smaller than an opening dimension of the exit port;
a mounting seat which is disposed at a proximal portion of the spouting tube portion and which extends in a direction which intersects an axis of the spouting tube portion at right angles in a flange-like shape; and
a connecting portion having a bent plate shape which bends from the mounting seat to an inner circumferential side of the spouting tube portion into a substantially arc-like shape and disposed at a boundary portion between the mounting seat and the spouting tube portion, wherein
the housing comprises:
a holding tube portion for holding the gas generator on an inner circumferential side thereof; and
a connecting tube portion disposed from the holding tube portion to the exit port, having a riser surface which extends from an inner circumferential surface of the holding tube portion towards an axis of the holding tube portion, extending towards the exit port with an inside diameter dimension made smaller than that of the holding tube portion and lying consecutive to the compressed gas chamber with the discharge ports provided so as to penetrate from an inner circumference to an outer circumference thereof, and wherein
the guide is installed with the spouting tube portion extending towards the exit portion while defining a space between an inner circumferential surface of the connecting tube portion and itself and the mounting seat brought into abutment with the riser surface so as to be held on the holding tube.

2. An inflator as set forth in claim 1, wherein
the guide is held in the housing by the mounting seat being press fitted in a portion of the holding tube portion in the housing where the riser surface is situated.

3. An inflator as set forth in claim 1, wherein
the gas generator is provided with a plurality of door portions on a surface thereof which faces the exit port which open at rupture portions formed to be ruptured radially from a center thereof when the combustion gas is spouted when the inflator is activated, and wherein
the guide is held in the housing and is disposed in a position where the guide can receive the respective doors which open when the gas generator spouts the combustion gas by an inner circumferential surface of the connecting portion.
